(19) United States
(12) Patent Application Publication
(10) Pub. No.: US 2014/0199071 A1
(43) Pub. Date: Jul. 17, 2014

(54) METHOD OF PROCESSING DMX-VLC ADDRESS USING DMX-512 NETWORK AND DEVICE USING THE SAME

(71) Applicant: Electronics and Telecommunications Research Institute, Daejeon (KR)

(72) Inventors: In-Su KIM, Daejeon (KR); Tae-Gyu KANG, Daejeon (KR); Sang-Kyu LIM, Daejeon (KR); Seong-Hee PARK, Daejeon (KR); Hyun-Joo KANG, Daejeon (KR); Hyun-Chul KANG, Daejeon (KR); Dae-Ho KIM, Daejeon (KR); Myung-Soon KIM, Daejeon (KR); You-Jin KIM, Daejeon (KR); Jung-Sik SUNG, Daejeon (KR); Il-Soon JANG, Daejeon (KR); Hyun-Seok KIM, Daejeon (KR); Hyun-Jong KIM, Cheongju-si (KR); Jin-Doo JEONG, Daejeon (KR)

(73) Assignee: Electronics and Telecommunications Research Institute, Daejeon (KR)

(21) Appl. No.: 14/147,258

(22) Filed: Jan. 3, 2014

(30) Foreign Application Priority Data
Jan. 17, 2013 (KR) 10-2013-0005531

(51) Int. Cl. H04L 29/06; H04B 10/116

(52) U.S. Cl. CPC H04L 69/22; H04B 10/116
USPC 398/66

(57) ABSTRACT

The present invention relates to a method of processing a Digital Multiplex (DMX)-Visible Light Communication (VLC) address and a device using the method. In the method of processing a DMX-VLC address, a DMX-512 packet is received. It is determined whether the DMX-512 packet includes dimming data by using a start code of the DMX-512 packet. Lighting data is processed using an address recorded in a DMX-512 address field of a DMX-VLC address included in the DMX-512 packet if it is determined that the DMX-512 packet includes the dimming data. Non-lighting data is processed using an address recorded in a DMX-VLC extended address field of the DMX-VLC address if it is determined that the DMX-512 packet does not include dimming data.

### CROSS REFERENCE TO RELATED APPLICATION

This application claims the benefit of Korean Patent Application No. 10-2013-0005531 filed on Jan. 17, 2013, which is hereby incorporated by reference in its entirety into this application.

### BACKGROUND OF THE INVENTION

1. Technical Field

The present invention relates generally to a lighting control network using Digital Multiplex (DMX)-512 and, more particularly, to an address system and addressing technology that can identify a DMX-Visible Light Communication (VLC) lighting device in a DMX-512 network.

2. Description of the Related Art

As the use of lighting devices employing an LED, which is a semiconductor device capable of transmitting information using visible light, as a light source, has increased, a lot more attention has been given to a large number of services for transferring information using lighting devices. Visible Light Communication (VLC) systems using LED lighting require a lighting control network required to transmit VLC data from a data provider to lighting devices.

Currently, Digital Multiplex (DMX)-512 used as lighting control network technology is used for the purpose of transferring lighting data (dimming data). Basically, DMX-512 technology can transmit dimming data of 1 byte per channel using 512 channels. When visible light communication data is allocated to DMX-512 channels using the characteristics of DMX-512, DMX-512 can also be used to transfer communication data to be used for visible light communication, as well as transfer dimming data.

When a DMX-512 address system is used, a maximum of 512 VLC transmitters can be identified and then VLC data can be transmitted. Generally, in a large-scale lighting system implemented using DMX-512 technology, there are many cases where different lighting devices are turned on in response to the same control data. Therefore, there is a case where not all lighting devices in a lighting system have unique DMX-512 addresses, and lighting devices exhibiting the same light are clustered into a group and have the same DMX-512 address.

Further, there is a case where a DMX-VLC lighting device having a VLC data transmission function desires to transmit different types of VLC data even if it exhibits the same light as lighting. Then, there is a limitation in that it is insufficient to use only an existing DMX-512 address as an identifier required to identify a DMX-VLC lighting device for performing a visible light communication function.

Therefore, new addressing technology is urgently required which can maintain compatibility with an existing DMX-512 address system while accurately addressing different DMX-VLC lighting devices having the same DMX-512 address among DMX-VLC lighting devices connected over a DMX-512 network.

Prior art related to this includes Korean Unexamined Patent Publication No. 2011-0061069 that discloses an LED lighting device that controls DMX-512 data so that the DMX-512 data can be transmitted in conformity with DMX-512 protocol.

### SUMMARY OF THE INVENTION

Accordingly, the present invention has been made keeping in mind the above problems occurring in the prior art, and an object of the present invention is to provide a DMX-VLC address system, which can accurately identify a lighting device for performing visible light communication among lighting devices connected over a DMX-512 lighting control network.

Another object of the present invention is to accurately address a desired lighting device even within a group of lighting devices clustered together by the same DMX-512 address.

A further object of the present invention is to identify a lighting device that is not identified using only an existing DMX-512 address while maintaining compatibility with an existing DMX-512 address system, and transmit VLC data to the identified lighting device, thus efficiently performing visible light communication using lighting devices connected over a DMX-512 network.

In accordance with an aspect of the present invention to accomplish the above objects, there is provided a method of processing a Digital Multiplex (DMX)-Visible Light Communication (VLC) address, including receiving a DMX-512 packet; determining whether the DMX-512 packet includes dimming data by using a start code of the DMX-512 packet; processing lighting data using an address recorded in a DMX-512 address field of a DMX-VLC address included in the DMX-512 packet if it is determined that the DMX-512 packet includes the dimming data; and processing non-lighting data using an address recorded in a DMX-VLC extended address field of the DMX-VLC address if it is determined that the DMX-512 packet does not include dimming data.

Preferably, the DMX-VLC address may be a 2-byte address, the DMX-512 address field includes 9 bits, and the DMX-VLC extended address field includes 7 bits.

Preferably, the DMX-VLC extended address field may include 7 consecutive bits including a Most Significant Bit (MSB) of the DMX-VLC address, and the DMX-512 address field may include 9 consecutive bits including a Least Significant Bit (LSB) of the DMX-VLC address.

Preferably, processing the lighting data may be configured to extract the address recorded in the DMX-512 address field using a DMX-512 address mask.

Preferably, the DMX-512 address mask may be a 2-byte structure, upper 7 bits of the DMX-512 address mask may be set to 0, and lower 9 bits thereof may be set to 1.

Preferably, processing the lighting data may be configured to extract the address recorded in the DMX-512 address field by performing an AND operation on the DMX-512 address mask and the DMX-VLC address.

Preferably, the DMX-VLC extended address field may include an address corresponding to a broadcast. In this case, the broadcast address may be an address with all bits set to 1.

Preferably, in the method, if the DMX-512 packet is received, a termination flag may be immediately released, and the termination flag may be set only when processing of non-lighting data corresponds to a specific VLC lighting device.

In accordance with another aspect of the present invention to accomplish the above objects, there is provided a Visible Light Communication (VLC) lighting device, including a Digital Multiplex (DMX) signal reception unit for receiving a DMX-512 packet; a DMX signal determination unit for determining whether the DMX-512 packet includes dimming data by using a start code of the DMX-512 packet; a dimming data processing unit for processing lighting data using an address recorded in a DMX-512 address field of a DMX-VLC address included in the DMX-512 packet if it is determined that the DMX-512 packet includes the dimming data; and a VLC data processing unit for processing VLC data using an address recorded in a DMX-VLC extended address field of the DMX-VLC address if it is determined that the DMX-512 packet does not include dimming data.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a system to which a method of processing a DMX-VLC address using a DMX-512 network according to an embodiment of the present invention is applied;

FIG. 2 is a diagram showing a DMX-VLC address system according to an embodiment of the present invention;

FIG. 3 is a block diagram showing a visible light communication lighting device according to an embodiment of the present invention; and

FIG. 4 is an operation flowchart showing a method of processing a DMX-VLC address according to an embodiment of the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, preferred embodiments of the present invention will be described in detail with reference to the attached drawings.

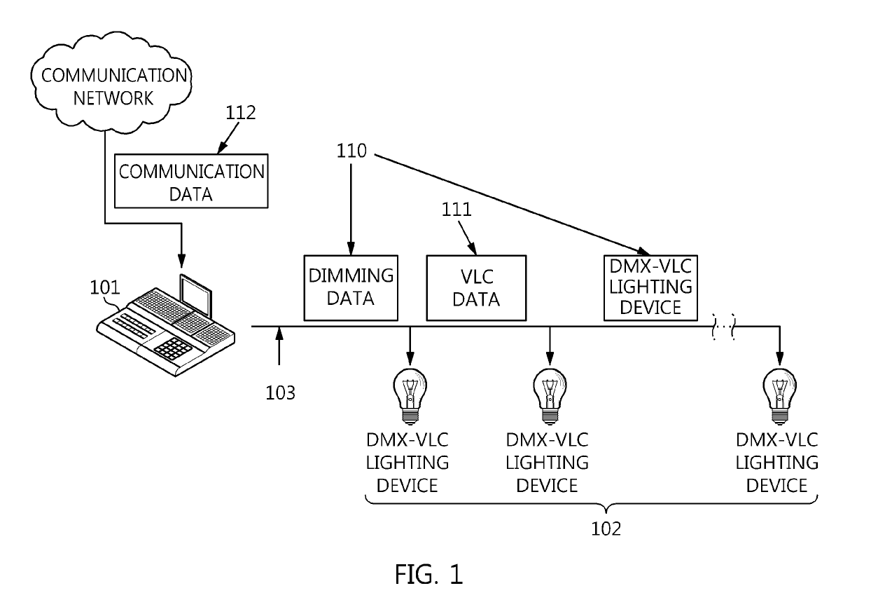

FIG. 1 is a diagram showing a system (DMX-512 network system) to which a method of processing a DMX-VLC address using a DMX-512 network according to an embodiment of the present invention is applied.

Referring to FIG. 1, the DMX-512 network system includes a lighting control device 101 and one or more DMX-VLC lighting devices 102.

The lighting control device 101 is connected to a data communication network, such as the Internet, and is configured to transmit and receive communication data to be used for Visible Light Communication data (VLC frame) 112.

Each of the DMX-VLC lighting devices 102 is a device having the function of receiving data from the lighting control device 101 using DMX-512 communication technology and transmitting information using visible light by means of a VLC function if necessary. The lighting control device 101 and each DMX-VLC lighting device 102 are connected to each other through a DMX line 103. Lighting step data (dimming data) 110 used for typical lighting control and VLC data 111 for visible light communication can be transmitted together through the DMX line. In this case, both the dimming data 110 and the VLC data 111 may have the form of packets. The lighting control device 101 lengthens the transmission interval of dimming data within an allowable limit conforming to the DMX-512 standard, and transmits the VLC data between the transmission times of the dimming data. The VLC data may be generated based on the communication data 112, wherein the VLC data and the communication data may have the same values, but the protocols thereof based on transmission technology may be different from each other.

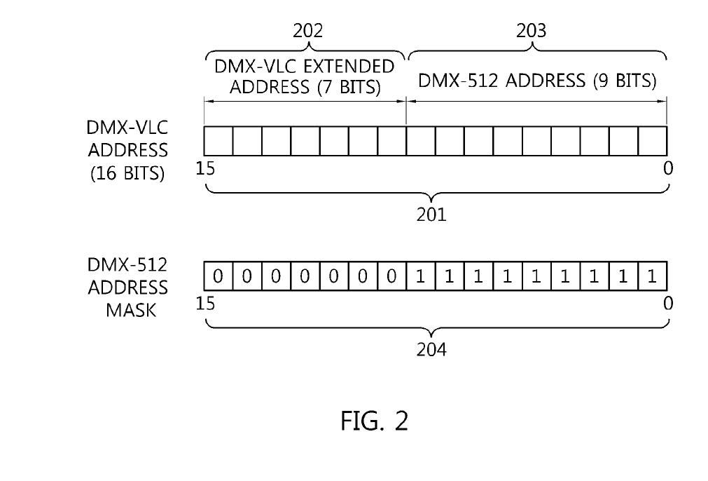

FIG. 2 is a diagram showing a DMX-VLC address system according to an embodiment of the present invention.

Referring to FIG. 2, it can be seen that a DMX-VLC address 201 is composed of 2 bytes (16 bits). In this case, the DMX-VLC address 201 is an address required by a lighting control device shown in FIG. 1 to identify a DMX-VLC lighting device.

This is because a DMX-512 network is based on the processing of byte-based data, and a minimum of 2-byte address space is required to represent 512 addresses.

Since the DMX-512 network can theoretically connect up to 512 lighting devices, a maximum of 512 DMX-512 addresses are required. DMX-512 communication enabling dimming data to be transferred is implemented such that a DMX-512 packet in which 512 pieces of data are sequentially connected is transmitted, and the lighting device having received the DMX-512 packet extracts only data having a number corresponding to a DMX-512 address preset in the lighting device and uses the extracted data.

When it is desired to transmit VLC data to the lighting device, an arbitrary DMX-VLC lighting device is specified and a VLC data packet is transmitted to the DMX-VLC lighting device, unlike the transmission of dimming data, and then DMX-VLC address information indicative of the final destination of the VLC data packet is essentially required.

If DMX-VLC addresses used to transmit non-lighting data, such as VLC data, and DMX-512 addresses used to transmit dimming data are used with the same values, it is impossible to exactly designate a specific lighting device in a large-scale lighting system in which two or more lighting devices use the same DMX-512 address.

Furthermore, DMX-VLC addresses may be present completely independently of DMX-512 addresses, but the lighting device must manage both DMX-512 addresses required to process dimming data and DMX-VLC addresses required to process non-lighting data, such as VLC data, thus causing a waste of data space and difficulty in management.

Therefore, the present invention provides an address system capable of processing both dimming data and non-lighting data, such as VLC data, without causing a waste of data space.

In order to represent 512 addresses in the 2-byte DMX-VLC address 201 shown in FIG. 2, 9 bits are used, which correspond to a DMX-512 address field 203.

If 9 bits are excluded from 2 bytes, 7 bits remain. Such 7 bits correspond to a DMX-VLC extended address field 202.

That is, the present invention solves the problem of a difficulty in identifying a DMX-VLC lighting device upon transmitting non-lighting data such as VLC data, without requiring additional space, by employing a method of allocating additional information to 7 bits remaining after representing DMX-512 addresses.

Consequently, the DMX-VLC address 201 includes a DMX-VLC extended address field 202 and a DMX-512 address field 203.

The DMX-512 address field 203 has conventional DMX-512 address values without change.

The DMX-VLC extended address field 202 has values required to identify DMX-VLC lighting devices having the same DMX-512 address.

In a single DMX-512 network, a lighting device, the DMX-512 address and the DMX-VLC extended address of which are identical to each other, may not be present. That is, the DMX-VLC address 201 formed by combining the DMX-512 address field 203 with the DMX-VLC extended address field 202 is unique within a single DMX-512 network.

A single DMX-VLC address 201 described above is allocated to each of the DMX-VLC lighting devices.

When a DMX-512 dimming data packet is received by the corresponding DMX-VLC lighting device, there is a need to extract only a DMX-512 address so as to obtain the corresponding dimming data. In this case, the extraction of the DMX-512 address can be performed using a DMX-512 address mask 204.

The DMX-512 address mask 204 may be composed of 2 bytes, in which only bits corresponding to the DMX-512 address have values of 1. The DMX-VLC lighting device may extract the DMX-512 address by performing an AND operation on the DMX-VLC address 201 and the DMX-512 address mask 204.

Binary values ranging from “0000000” to “1111110” can be allocated to the DMX-VLC extended address field 202, wherein the binary value “1111111” may be used as a broadcast address. When “1111111” is used as a broadcast address, no DMX-VLC lighting device can be allocated the address.

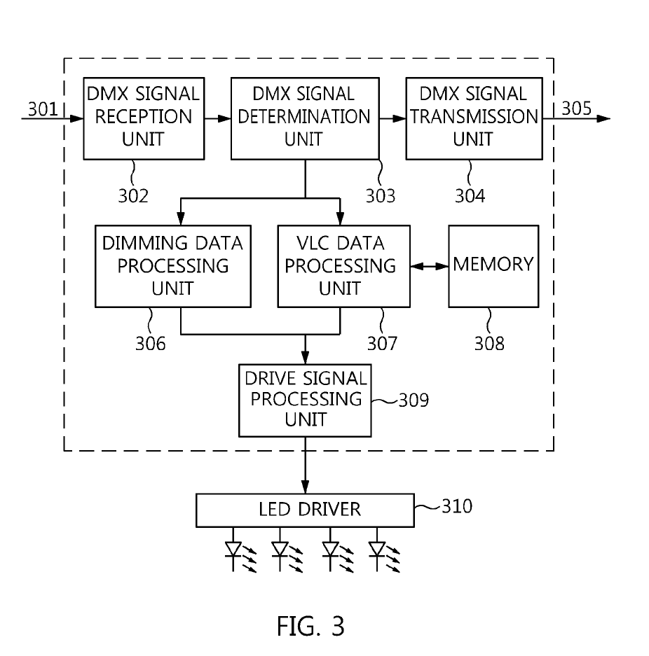

FIG. 3 is a block diagram showing a visible light communication lighting device according to an embodiment of the present invention.

Referring to FIG. 3, the VLC lighting device according to the embodiment of the present invention includes a DMX signal reception unit 302, a DMX signal determination unit 303, a DMX signal transmission unit 304, a dimming data processing unit 306, a VLC data processing unit 307, memory 308, a drive signal processing unit 309, and an LED driver 310.

In particular, the VLC lighting device shown in FIG. 3 may correspond to the DMX-VLC lighting device shown in FIG. 1.

The DMX signal reception unit 302 transmits a DMX-512 packet input through a DMX input line 301 to the DMX signal determination unit 303.

The DMX signal determination unit 303 transfers the DMX-512 packet to the dimming data processing unit 306 or to the VLC data processing unit 307 according to the Start Code (SC) of the received DMX-512 packet. In this case, the DMX signal determination unit 303 may check the DMX-VLC address of the received DMX-512 packet, check the start code of the packet only if the DMX-VLC address is identical to the address of the corresponding DMX-VLC lighting device (VLC lighting device), and then transmit the DMX-512 packet to the dimming data processing unit 306 or the VLC data processing unit 307.

In this case, the DMX signal determination unit 303 transmits control information to the dimming data processing unit 306 if the start code of the received DMX-512 packet is 0, so that lighting is turned on via the drive signal processing unit 309 and the LED driver 310.

If the start code of the DMX-512 packet is a value set for visible light communication other than 0, the DMX signal determination unit 303 sends the data of the received DMX-512 packet to the VLC data processing unit 307, so that visible light communication is performed. The VLC data processing unit 307 accumulates data in the memory 308 until data of a DMX-512 packet having fragmentation information of 0 is received. If a DMX-512 packet having fragmentation information of 0 is received, the VLC data processing unit 307 loads data from the memory, generates a completed VLC frame, and transmits the data of the VLC frame via visible light communication through the drive signal processing unit 309 and the LED driver 310.

The DMX signal determination unit 303 may selectively transfer the received DMX-512 packet to the DMX signal transmission unit 304. The DMX signal transmission unit 304 transmits the received DMX-512 packet to another lighting device through a DMX output line 305.

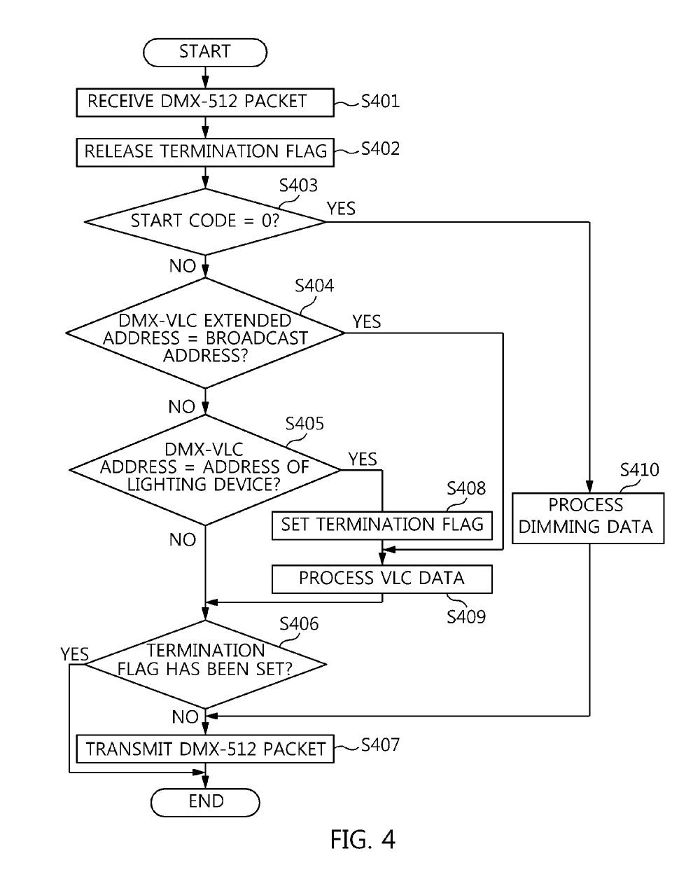

FIG. 4 is an operation flowchart showing a method of processing a DMX-VLC address according to an embodiment of the present invention.

Referring to FIG. 4, in the DMX-VLC address processing method using the DMX-512 network according to the embodiment of the present invention, a DMX-512 packet is received at step S401.

Then, in the DMX-VLC address processing method, a termination flag for discontinuing retransmission is released at step S402.

Next, in the DMX-VLC address processing method, it is determined whether a Start Code (SC) included in the DMX-512 packet is a value for dimming data at step S403.

For example, the value of the start code for dimming data may be 0.

In the DMX-VLC address processing method, if it is determined at step S403 that the value of the start code is 0, lighting is turned on according to a typical procedure for processing the DMX-512 packet at step S410. That is, when the value of the start code is 0, the DMX-512 packet is transferred to the dimming data processing unit shown in FIG. 3. The dimming data processing unit processes lighting data (dimming data) using an address recorded in the DMX-512 address field of a DMX-VLC address included in the DMX-512 packet.

In this case, the DMX-VLC address may be a 2-byte address, wherein 9 bits may be allocated to the DMX-512 address field, and 7 bits may be allocated to a DMX-VLC extended address field. In this case, 7 consecutive bits including the Most Significant Bit (MSB) of the DMX-VLC address may be allocated to the DMX-VLC extended address field, and 9 consecutive bits including the Least Significant Bit (LSB) of the DMX-VLC address may be allocated to the DMX-512 address field.

Here, step S410 is configured to extract an address recorded in the DMX-512 address field using a DMX-512 address mask. In this case, as shown in FIG. 2, the DMX-512 address mask has a 2-byte structure, wherein the upper 7 bits of the DMX- 512 address mask may be set to 0 and lower 9 bits thereof may be set to 1. In this case, the extraction of the address recorded in the DMX-512 address field may be performed by performing an AND operation on the DMX-512 address mask and the DMX-VLC address.

After the processing of the lighting data has been terminated, the DMX-512 packet is transmitted to another DMX-VLC lighting device at step S407.

Meanwhile, if it is determined at step S403 that the start code has a value corresponding to non-lighting data, such as VLC data, other than 0, it is determined whether an address recorded in the DMX-VLC extended address field of the DMX-VLC address included in the DMX-512 packet is an address corresponding to a broadcast at step S404.

In this case, the address corresponding to the broadcast may be “1111111.”

In the DMX-VLC address processing method, if it is determined at step S404 that the address recorded in the DMX-VLC extended address field corresponds to the broadcast, the processing of VLC data corresponding to the broadcast is performed at step S409.

In this case, step S409 may be configured such that the VLC data processing unit shown in FIG. 3 performs the processing of non-lighting data, such as the processing of VLC data, using the data included in the DMX-512 packet.

In the DMX-VLC address processing method, if it is determined at step S404 that the address recorded in the DMX-VLC extended address field does not correspond to the broadcast, it is determined whether the DMX-VLC address included in the DMX-512 packet is an address corresponding to a relevant lighting device at step S405.

In the DMX-VLC address processing method, if it is determined at step S405 that the DMX-VLC address is the address corresponding to the relevant lighting device, a termination flag for preventing retransmission is set at step S408, and the processing of VLC data is performed at step S409.

In the DMX-VLC address processing method, if it is determined at step S405 that the DMX-VLC address does not correspond to the relevant lighting device, or if the processing of VLC data has been terminated at step S409, it is determined whether the termination flag has been set at step S406.

In the DMX-VLC address processing method, if it is determined at step S406 that the termination flag has been set, the operations of the DMX-VLC address processing method are terminated, whereas if it is determined at step S406 that the termination flag has not been set, the DMX-512 packet is transmitted to another lighting device at step S407.

In this case, step S407 may be a step performed by the DMX signal transmission unit shown in FIG. 3.

In accordance with the present invention, there can be provided a DMX-VLC address system, which can accurately identify a lighting device for performing visible light communication among lighting devices connected over a DMX-512 lighting control network.

Further, the present invention can accurately address a desired lighting device even within a group of lighting devices clustered together by the same DMX-512 address.

Furthermore, the present invention can identify a lighting device that is not identified using only an existing DMX-512 address while maintaining compatibility with an existing DMX-512 address system, and transmit VLC data to the identified lighting device, thus efficiently performing visible light communication using lighting devices connected over a DMX-512 network.

As described above, in the method and device for processing a DMX-VLC address using a DMX-512 network according to the present invention, the configurations and schemes in the above-described embodiments are not limitedly applied, and some or all of the above embodiments can be selectively combined and configured so that various modifications are possible.

What is claimed is:

1. A method of processing a Digital Multiplex (DMX)-Visible Light Communication (VLC) address, comprising:
receiving a DMX-512 packet;
determining whether the DMX-512 packet includes dimming data by using a start code of the DMX-512 packet;
processing lighting data using an address recorded in a DMX-512 address field of a DMX-VLC address included in the DMX-512 packet if it is determined that the DMX-512 packet includes the dimming data; and
processing non-lighting data using an address recorded in a DMX-VLC extended address field of the DMX-VLC address if it is determined that the DMX-512 packet does not include dimming data.

2. The method of claim 1, wherein the DMX-VLC address is a 2-byte address, the DMX-512 address field includes 9 bits, and the DMX-VLC extended address field includes 7 bits.

3. The method of claim 2, wherein the DMX-VLC extended address field includes 7 consecutive bits including a Most Significant Bit (MSB) of the DMX-VLC address, and the DMX-512 address field includes 9 consecutive bits including a Least Significant Bit (LSB) of the DMX-VLC address.

4. The method of claim 3, wherein processing the lighting data is configured to extract the address recorded in the DMX-512 address field using a DMX-512 address mask.

5. The method of claim 4, wherein:
the DMX-512 address mask is a 2-byte structure, and
upper 7 bits of the DMX-512 address mask are set to 0, and lower 9 bits thereof are set to 1.

6. The method of claim 5, wherein processing the lighting data is configured to extract the address recorded in the DMX-512 address field by performing an AND operation on the DMX-512 address mask and the DMX-VLC address.

7. The method of claim 3, wherein the DMX-VLC extended address field includes an address corresponding to a broadcast.

8. The method of claim 7, wherein the broadcast address is an address with all bits set to 1.

9. The method of claim 7, wherein if the DMX-512 packet is received, a termination flag is immediately released, and the termination flag is set only when processing of non-lighting data corresponds to a specific VLC lighting device.

10. A Visible Light Communication (VLC) lighting device, comprising:
a Digital Multiplex (DMX) signal reception unit for receiving a DMX-512 packet;
a DMX signal determination unit for determining whether the DMX-512 packet includes dimming data by using a start code of the DMX-512 packet;
a dimming data processing unit for processing lighting data using an address recorded in a DMX-512 address field of a DMX-VLC address included in the DMX-512 packet if it is determined that the DMX-512 packet includes the dimming data; and
a VLC data processing unit for processing VLC data using an address recorded in a DMX-VLC extended address field of the DMX-VLC address if it is determined that the DMX-512 packet does not include dimming data.

11. The VLC lighting device of claim 10, wherein the DMX-VLC address is a 2-byte address, the DMX-512 address field includes 9 bits, and the DMX-VLC extended address field includes 7 bits.

12. The VLC lighting device of claim 11, wherein the DMX-VLC extended address field includes 7 consecutive bits including a Most Significant Bit (MSB) of the DMX-VLC address, and the DMX-512 address field includes 9 consecutive bits including a Least Significant Bit (LSB) of the DMX-VLC address.

13. The VLC lighting device of claim 12, wherein the dimming data processing unit extracts the address recorded in the DMX-512 address field using a DMX-512 address mask.

14. The VLC lighting device of claim 13, wherein:
the DMX-512 address mask is a 2-byte structure, and
upper 7 bits of the DMX-512 address mask are set to 0, and lower 9 bits thereof are set to 1.

15. The VLC lighting device of claim 14, wherein the dimming data processing unit extracts the address recorded in the DMX-512 address field by performing an AND operation on the DMX-512 address mask and the DMX-VLC address.

16. The VLC lighting device of claim 12, wherein the DMX-VLC extended address field includes an address corresponding to a broadcast.

17. The VLC lighting device of claim 16, wherein the broadcast address is an address with all bits set to 1.

18. The VLC lighting device of claim 16, wherein if the DMX-512 packet is received, a termination flag is immediately released, and the termination flag is set only when processing of non-lighting data corresponds to the VLC lighting device.
